(19) United States
(12) Patent Application Publication
(10) Pub. No.: US 2007/0177501 A1
(43) Pub. Date: Aug. 2, 2007

(54) Signaling Requirements to Support Interference Coordination in OFDMA Based Systems

(75) Inventor: Aris Papasakellariou, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/627,095

(22) Filed: Jan. 25, 2007

Related U.S. Application Data
(60) Provisional application No. 60/763,549, filed on Jan. 31, 2006.

(51) Int. Cl. H04L 12/26; H04Q 7/00

(52) U.S. Cl. 370/229; 370/329

(57) ABSTRACT

The invention provide methods for classifying user equipments (UEs) communicating with a serving base station (Node B) according to their experienced average interference in subsets of frequency or time resources. The classification utilizes existing channel quality indication (CQI) reports the UEs send to their serving Node B for the purposes of data scheduling. Multiple CQI reports are averaged to practically eliminate short term variations caused by fast fading and capture the long term interference and signal-to-interference and noise ratio (SINR) that the UEs experience. By capturing this average interference and SINR, a reference Node B can apply interference co-ordination through fractional frequency reuse or fractional time reuse.

### CROSS-REFERENCE TO RELATED APPLICATIONS

This application claims priority under 35 U.S.C. 119(e) to U.S. Provisional Application No. 60/763,549, filed Jan. 31, 2006, entitled “SIGNALING REQUIREMENTS TO SUPPORT INTER-CELL FREQUENCY PLANNING FOR INTERFERENCE MITIGATION IN OFDM BASED SYSTEMS”, Aris Papasakellariou inventor. Said application incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Embodiments of the invention are directed, in general, to communication systems and, more specifically, to reducing interference near the edge of cells in a communication system.

The global market for both voice and data communication services continues to grow as does users of the systems which deliver those services. As communication systems evolve, system design has become increasingly demanding in relation to equipment and performance requirements. Future generations of communication systems, will be required to provide high quality high transmission rate data services in addition to high quality voice services. Orthogonal Frequency Division Multiplexing (OFDM) is a technique that will allow for high speed voice and data communication services.

Orthogonal Frequency Division Multiplexing (OFDM) is based on the well-known technique of Frequency Division Multiplexing (FDM). OFDM technique relies on the orthogonality properties of the fast Fourier transform (FFT) and the inverse fast Fourier transform (IFFT) to eliminate interference between carriers. At the transmitter, the precise setting of the carrier frequencies is performed by the IFFT. The data is encoded into constellation points by multiple (one for each carrier) constellation encoders. The complex values of the constellation encoder outputs are the inputs to the IFFT. For wireless transmission, the outputs of the IFFT are converted to an analog waveform, up-converted to a radio frequency, amplified, and transmitted. At the receiver, the reverse process is performed. The received signal (input signal) is amplified, down converted to a band suitable for analog to digital conversion, digitized, and processed by a FFT to recover the carriers. The multiple carriers are then demodulated in multiple constellation decoders (one for each carrier), recovering the original data. Since an IFFT is used to combine the carriers at the transmitter and a corresponding FFT is used to separate the carriers at the receiver, the process has potentially zero inter-carrier interference such as when the sub-carriers are separated in frequency by an amount larger than the maximum expected Doppler shift.

FIG. 1 is a diagram illustrative of the Frequency 103-Time 101 Representation 100 of an OFDM Signal. In FDM different streams of information are mapped onto separate parallel frequency channels 140. Each FDM channel is separated from the others by a frequency guard band to reduce interference between adjacent channels.

The OFDM technique differs from traditional FDM in the following interrelated ways:
1. multiple carriers (called sub-carriers 150) carry the information stream;
2. the sub-carriers 150 are orthogonal to each other; and
3. a Cyclic Prefix (CP) 110 (also known as guard interval) is added to each symbol 120 to combat the channel delay spread and avoid OFDM inter-symbol interference (ISI).

The data/information carried by each sub-carrier 150 may be user data of many forms, including text, voice, video, and the like. In addition, the data includes control data, a particular type of which is discussed below. As a result of the orthogonality, ideally each receiving element tuned to a given sub-carrier does not perceive any of the signals communicated at any other of the sub-carriers. Given this aspect, various benefits arise. For example, OFDM is able to use orthogonal sub-carriers and, as a result, thorough use is made of the overall OFDM spectrum. As another example, in many wireless systems, the same transmitted signal arrives at the receiver at different times having traveled different lengths due to reflections in the channel between the transmitter and receiver. Each different arrival of the same originally-transmitted signal is typically referred to as a multi-path. Typically, multi-paths interfere with one another, which is sometimes referred to as InterSymbol Interference (ISI) because each path includes transmitted data referred to as symbols. Nonetheless, the orthogonality implemented by OFDM with a CP considerably reduces or eliminates ISI and, as a result, often a less complex receiver structure, such as one without an equalizer (one-tap “equalizer” is used), may be implemented in an OFDM system.

The Cyclic Prefix (CP) (also referred to as guard interval) is added to each symbol to combat the channel delay spread and avoid ISI. FIG. 2 is a diagram illustrative of using CP to eliminate ISI and perform frequency domain equalization. Blocks 200 each comprising cyclic prefix (CP) 210 coupled to data symbols 220 to perform frequency domain equalization. OFDM typically allows the application of simple, 1-tap, frequency domain equalization (FDE) through the use of a CP 210 at every FFT processing block 200 to suppress multi-path interference. Two blocks are shown for drawing convenience. CP 210 eliminates inter-data-block interference and multi-access interference using Frequency Division Multiple Access (FDMA).

Since orthogonality is typically guaranteed between overlapping sub-carriers and between consecutive OFDM symbols in the presence of time/frequency dispersive channels, the data symbol density in the time-frequency plane can be maximized and high data rates can be very efficiently achieved for high Signal-to-Interference and Noise Ratios (SINR).

FIG. 3 is a diagram illustrative of CP Insertion. A number of samples is typically inserted between useful OFDM symbols 320 (guard interval) to combat OFDM ISI induced by channel dispersion, assist receiver synchronization, and aid spectral shaping. The guard interval 310 is typically a prefix that is inserted 350 at the beginning of the useful OFDM symbol (OFDM symbol without the CP) 320. The CP duration 315 should be sufficient to cover most of the delay-spread energy of a radio channel impulse response. It should also be as small as possible since it represents overhead and reduces OFDM efficiency. Prefix 310 is generated using a last block of samples 340 from the useful OFDM symbol 330 and is therefore a cyclic extension to the OFDM symbol (cyclic prefix).

When the channel delay spread exceeds the CP duration 315, the energy contained in the ISI should be much smaller than the useful OFDM symbol energy and therefore, the OFDM symbol duration 325 should be much larger than the channel delay spread. However, the OFDM symbol duration 325 should be smaller than the minimum channel coherence time in order to maintain the OFDM ability to combat fast temporal fading. Otherwise, the channel may not always be constant over the OFDM symbol and this may result in inter-sub-carrier orthogonality loss in fast fading channels. Since the channel coherence time is inversely proportional to the maximum Doppler shift (time-frequency duality), this implies that the symbol duration should be much smaller than the inverse of the maximum Doppler shift.

The large number of OFDM sub-carriers makes the bandwidth of individual sub-carriers small relative to the total signal bandwidth. With an adequate number of sub-carriers, the inter-carrier spacing is much narrower than the channel coherence bandwidth. Since the channel coherence bandwidth is inversely proportional to the channel delay spread, the sub-carrier separation is generally designed to be much smaller that the inverse of the channel coherence time. Then, the fading on each sub-carrier appears flat in frequency and this enables 1-tap frequency equalization, use of high order modulation, and effective utilization of multiple transmitter and receiver antenna techniques such as Multiple Input/Multiple Output (MIMO). Therefore, OFDM effectively converts a frequency-selective channel into a parallel collection of frequency flat sub-channels and enables a very simple receiver. Moreover, in order to combat Doppler effects, the inter-carrier spacing should be much larger than the maximum Doppler shift.

FIG. 4 shows the concepts of frequency diversity 400 and multi-user diversity 405. Using link adaptation techniques based on the estimated dynamic channel properties, the OFDM transmitter can adapt the transmitted signal to each User Equipment (UE) to match channel conditions and approach the ideal capacity of frequency-selective channel. Thanks to such properties as flattened channel per sub-carrier, high-order modulation, orthogonal sub-carriers, and MIMO; it is possible to improve spectrum utilization and increase achievable peak data rate in OFDM system. Also, OFDM can provide scalability for various channel bandwidths (i.e. 1.25, 2.5, 5, 10, 20 MHz) without significantly increasing complexity.

OFDM may be combined with Frequency Division Multiple Access (FDMA) in an Orthogonal Frequency Division Multiple Access (OFDMA) system to allow multiplexing of multiple UEs over the available bandwidth. Because OFDMA assigns UEs to isolated frequency sub-carriers, intra-cell interference may be avoided and high data rate may be achieved. The base station (or Node B) scheduler assigns physical channels based on Channel Quality Indication (CQI) feedback information from the UEs, thus effectively controlling the multiple-access mechanism in the cell. For example, in FIG. 4, transmission to each of the three UEs 401, 402, 403 is scheduled at frequency sub-bands where the channel frequency response allows for higher SINR relative to other sub-bands. This is represented by the Received signal levels R401, R402, and R403 for users 401, 402 and 403 at Frequencies F401, F402, and F403 respectively.

OFDM can use frequency-dependent scheduling with optimal per sub-band Modulation & Coding Scheme (MCS) selection. For each UE and each Transmission Time Interval (TTI), the Node B scheduler selects for transmission with the appropriate MCS a group of the active UEs in the cell, according to some criteria that typically incorporate the achievable SINR based on the CQI feedback. In addition, sub-carriers or group of sub-carriers may be reserved to transmit pilot, control signaling or other channels. Multiplexing may also be performed in the time dimension, as long as it occurs at the OFDM symbol rate or at a multiple of the symbol rate (i.e. from one TTI to the next). The MCS used for each sub-carrier or group of sub-carriers can also be changed at the corresponding rate, keeping the computational simplicity of the FFT-based implementation. This allows 2-dimensional time-frequency multiplexing, as shown in FIG. 5 and FIG. 6.

Transmission Time Interval (TTI) may also be referred to as a sub-frame which is a part of a frame with larger time duration. For example, a sub-frame may have duration of 1 millisecond and a frame may have duration of 10 milliseconds.

Turning now to FIG. 5, which is a diagram illustrative of a configuration for multi-user diversity, the minimum frequency sub-band used for frequency-dependent scheduling of a UE typically comprises several sub-carriers and may be referred to as a sub-band or a Resource Block (RB) 520. Reference number 520 is only pointing to one of the 8 RBs per OFDM symbol shown as example and for drawing clarity. RB 520 is shown with RB bandwidth 525 (typically comprising of a predetermined number of sub-carriers) in frequency dimension and time duration 510 (typically comprising of a predetermined number of OFDM symbols such as one sub-frame) in time dimension. Each RB may be comprised of continuous sub-carriers and thus be localized in nature to afford frequency-dependent scheduling. A high data rate UE may use several RBs within same TTI 530. UE #1 is shown as an example of a high rate UE. Low data rate UEs requiring few time-frequency resources may be multiplexed within the same RB 540 or, alternatively, the RB size may be selected to be small enough to accommodate the lowest expected data rate.

Alternatively referring to FIG. 6, which is a diagram illustrative of a configuration for frequency diversity, an RB 620 may correspond to a number of sub-carriers substantially occupying the entire bandwidth thereby offering frequency diversity. This may be useful in situations where CQI feedback is not available or it is unreliable (as is the case for high speed UEs). Another option to achieve frequency diversity is to assign to a UE two or more RBs with each RB comprising of contiguous sub-carriers but and with each RB occupying non-contiguous parts of the bandwidth.

By assigning transmission to various simultaneously scheduled UEs in different RBs, the Node B scheduler can provide intra-cell orthogonality among the various transmitted signals. Moreover, for each individual signal, the presence of the cyclic prefix provides protection from multipath propagation and maintains in this manner the signal orthogonality. Nevertheless, near the edge of each cell, the UEs are exposed to interference from the signals transmitted from Node Bs of adjacent cells to UEs near the edge of those cells. This interference (inter-cell interference) causes significant degradation in the SINR achieved by cell edge UEs and severely limits their potential performance. Conventional approaches in prior art attempt to address this problem by either applying hard frequency re-use, as in Global Systems for Mobile Communications GSM-type networks, or using interference cancellation, if it is possible and effective, as in Code Division Multiple Access CDMA-type networks.

In OFDMA-based communication systems, hard frequency re-use is not necessary as the communication with multiple UEs over the operating bandwidth is orthogonally divided among the multiple RBs the operating bandwidth is partitioned into. Instead, Interference Co-ordination methods based on soft Fractional Frequency Reuse (IC-FFR) or on soft Fractional Time Reuse (IC-FTR) can apply as for example described in U.S. patent application Ser. No. 11/535,867, filed on Sep. 27, 2006, entitled “METHODS FOR ASSIGNING RESOURCES IN A COMMUNICATION SYSTEM”, Aris Papasakellariou inventor (Attorney Docket Number: TI-61461) incorporated herein by reference. The main principles of IC-FFR and IC-FTR are further outlined for ease of reference.

IC-FFR co-ordinates the allocation of the RBs comprising the operating bandwidth among adjacent cells or Node Bs. This allocation can be achieved through static or semi-static Node B coordination taking into account the traffic load, i.e. the distribution (location and/or transmit power requirements) and throughput (data rate) requirements of UEs near the edge of each Node B. Knowing this traffic load information at the edge of each Node B in a network of Node Bs, a central unit, such as for example a master Node B or a radio network controller, can then allocate a set of RBs to each Node B. These RBs cannot be used with full transmission power by adjacent Node Bs to schedule UEs located near their corresponding edges. This means that in the RBs allocated to the reference Node B, adjacent Node Bs transmit with much reduced power, including no transmission, to UEs located near their corresponding edges. However, all Node Bs use the entire bandwidth to schedule UEs in their interior (soft fractional frequency re-use). Alternatively, the resources for communication with cell edge UEs may be assigned, without communication with a central node, based on long term statistics for cell edge data rate requirements in each Node B and be periodically re-configured over long time periods (such as hours).

An application of the exemplary IC-FFR method is shown in FIG. 7 for the exemplary setup of soft fractional frequency re-use of three. All Node Bs can use the entire available frequency spectrum to schedule UEs located in their interior but can use with full transmission power only a fraction of this spectrum in order to schedule UEs located near their edges. Scheduling of cell edge UEs is performed first followed by scheduling of UEs in the cell interior. Adjacent Node Bs transmit with reduced power, including no transmission (zero power), in the fraction of the frequency spectrum allocated to the reference Node B for use with priority by cell edge UEs.

Unlike the hard frequency re-use in GSM-like networks, IC-FFR achieves a frequency re-use of one and therefore has no reduction in bandwidth efficiency. The power restrictions for transmissions from adjacent Node Bs in the RBs reserved for use by cell edge UEs in a reference Node B can be viewed as a scheduler restriction and not as a bandwidth one. For the example of FIG. 7, assuming that all Node Bs have uniform traffic load distributions throughout their coverage area, that the cells have equal sizes or equal propagation losses at their edges, and that the traffic load is the same at the edge of all cells, an appropriate division of the available frequency spectrum for use near the cell edge is in three equal portions. In FIG. 7, cell 1 is allocated one-third of that spectrum 710, cells 2, 4, and 6 are allocated a second one-third 720, and cells 3, 5, and 7 are allocated the final one-third 730. When the Node B scheduler of any of the previous cells schedules a set of UEs for transmission, it may assign the one-third of these scheduled UEs it determines to be located closer to the cell edge (than the remaining two-thirds of UEs) in the one-third of reserved RBs this reference Node B has been allocated. The remaining two-thirds of scheduled UEs, deemed to be located closer to the cell interior, are scheduled in the remaining two-thirds of the available spectrum.

In synchronous networks, interference mitigation can be achieved with time scheduling coordination for the TTIs leading to interference co-ordination through fractional time re-use (IC-FTR). Like IC-FFR, IC-FTR is simply the application of scheduler restrictions in order to schedule cell edge UEs only during particular TTIs (sub-frames) where adjacent cells are allowed to schedule only cell interior UEs. Cell interior UEs are scheduled in every Node B in all TTIs. With stand-alone IC-FTR, the entire bandwidth is always used but cell edge UEs may be scheduled only during specific TTIs allocated for cell edge use to the corresponding Node B. Cell interior UEs may or may not be scheduled during TTIs where cell edge UEs belonging to the same Node B are allowed to be scheduled.

IC-FFR and IC-FTR may also be combined to allow for enhanced flexibility in resource allocation and managing dynamic traffic loads near cell edges, thereby improving cell edge and overall throughput. Similar to IC-FFR, IC-FTR can be static or semi-static with the latter allowing for more efficient resource allocation. For example, considering FIG. 7 only from a static IC-FTR perspective (all RBs available in every Node B), scheduling of cell edge UEs during a TTI for Cell 1, for Cells 2, 4, and 6, and for Cells 3, 5, and 7 may, respectively, occur only in TTIs for which TTI#modulo 3=0, TTI#modulo 3=1, and TTI#modulo 3=2.

For both IC-FFR and IC-FTR or their combination, the Node B scheduler requires means and methods to classify UEs according to the long term interference they experience (not necessarily according to the SINR or the location or the path loss). Clearly, this classification is fundamental for the feasibility of any IC-FFR or IC-FTR method. Moreover, the nature of the information required for the aforementioned UE classification should be such that it captures the dynamic changes with time in the UE and traffic load distributions throughout the area of each serving Node B, and particularly near the edge of that area, so that the parameters of IC-FFR or IC-FTR can be re-configured with time. Another significant consideration for the application of IC-FFR or IC-FTR is that they should avoid creating signaling overhead that would not be required by the conventional system operation as this new overhead may significantly diminish the potential throughput and spectral efficiency gains of IC-FFR or IC-FTR.

Thus, there is a need to develop a method for a Node B to classify its serving UEs according to metrics required for the application of IC-FFR or IC-FTR.

There is also another need for the Node B to exploit existing measurement reports that the Node B is provided from its serving UEs for other purposes in order to classify these UEs according to the requirements for the IC-FFR or IC-FTR application and avoid introducing additional signaling overhead.

### SUMMARY

Embodiments of the invention provide methods for classifying user equipments (UEs) communicating with a base station (Node B) according to their experienced average interference in subsets of frequency or time resources. The exemplary embodiment considers application of such classification for the purposes of interference co-ordination through fractional frequency reuse (IC-FFR), interference co-ordination through fractional time reuse (IC-FTR), or their combination. This classification utilizes existing channel quality indication (CQI) reports the UEs send periodically to their serving Node B for the purposes of data scheduling. The CQI reports are averaged over a longer time period to practically eliminate short term variations caused by fast fading and capture the long term interference and signal-to-interference and noise ratio (SINR) that the UEs experience.

By capturing the interference and the SINR a UE experiences in some or all of the resource blocks (RBs) comprising the total transmission bandwidth and having knowledge of the restrictions in the transmission power from adjacent Node Bs in a set of RBs, a reference Node B can classify each UE for the purposes of IC-FFR. Similarly, by capturing the SINR in some or all the sub-frames of a frame (over several such frames) and having knowledge of the restrictions in the transmission power from adjacent Node Bs in a set of sub-frames, a reference Node B can classify each UE for the purposes of IC-FTR.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 is a diagram illustrative of the Frequency-Time Representation of an OFDM Signal;

FIG. 2 is a diagram illustrative of using cyclic prefix (CP) to eliminate ISI and perform frequency domain equalization;

FIG. 3 is a diagram illustrative of Cyclic Prefix (CP) Insertion

FIG. 4 shows the concepts of frequency and multi-user diversity;

FIG. 5 is a diagram illustrative of a configuration for Multi-User Diversity;

FIG. 6 is a diagram illustrative of a configuration for frequency diversity;

FIG. 7 shows an exemplary cell structure highlighting the cell edges;

FIG. 8 shows channel quality indication (CQI) measurements for Cell Edge UEs;

FIG. 9 shows channel quality indication (CQI) measurements for Cell Interior UEs;

FIG. 10 shows channel quality indication (CQI) measurements for UEs in poor shadowing conditions;

FIG. 11 is a flowchart illustrative of an embodiment; and

FIG. 12 is a flowchart illustrative of an embodiment.

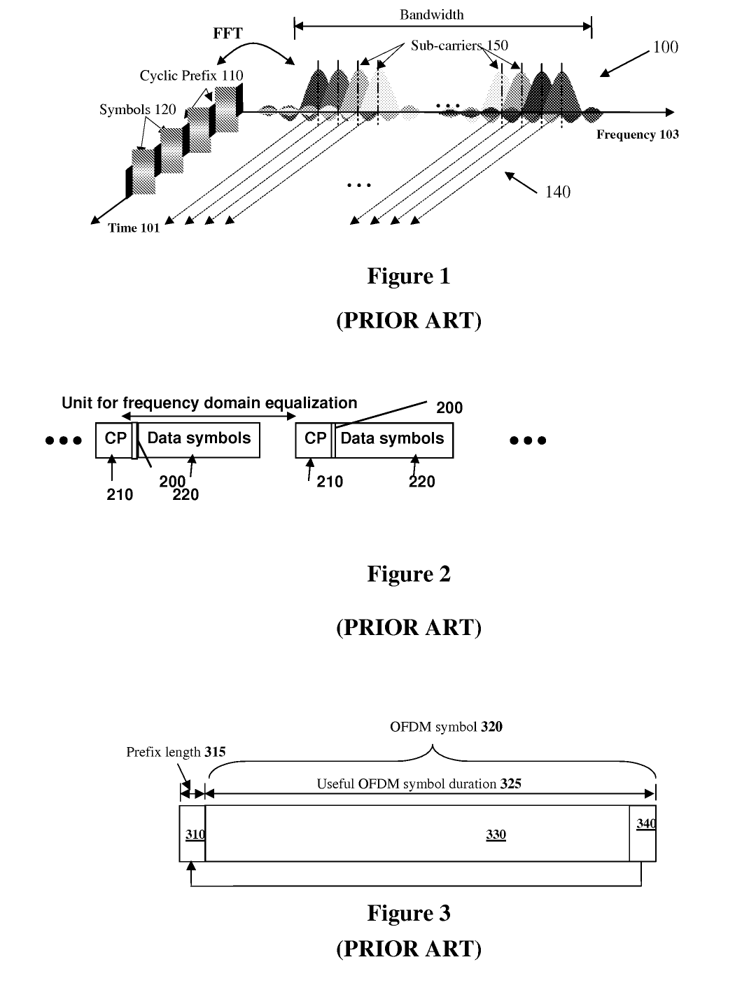

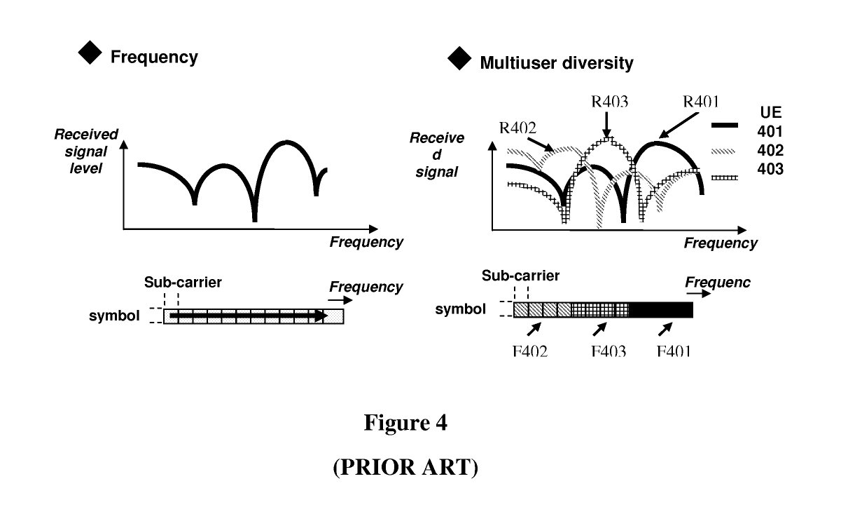

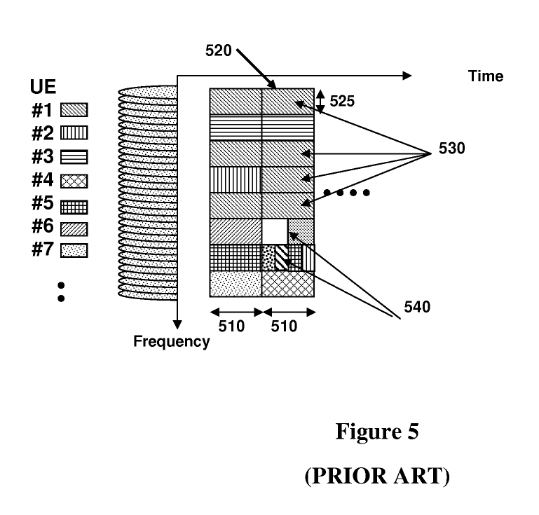

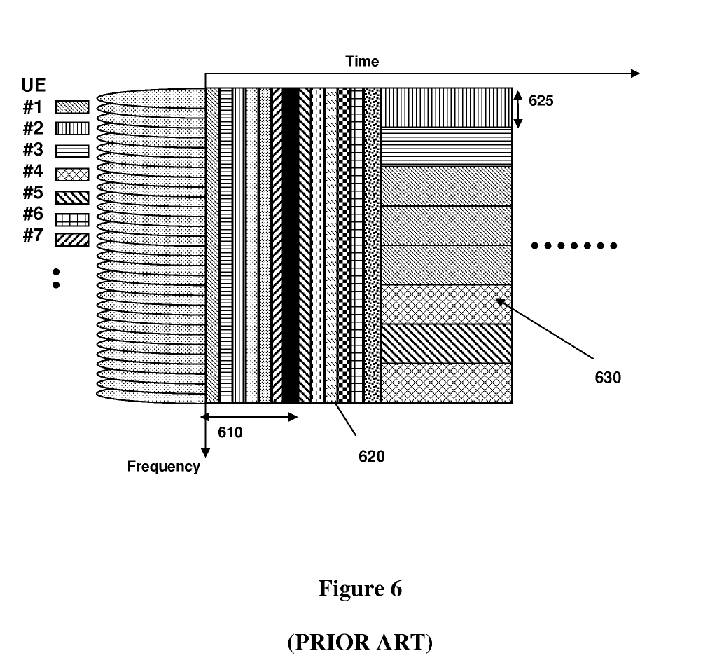

### DETAILED DESCRIPTION

It should be understood at the outset that although an exemplary implementation of one embodiment of the disclosure is illustrated below, the system may be implemented using any number of techniques, whether currently known or in existence. The disclosure should in no way be limited to the exemplary implementations, drawings, and techniques illustrated below, including the exemplary design and implementation illustrated and described herein, but may be modified within the scope of the appended claims along with their full scope of equivalents.

Embodiments of the invention address the problem of inter-cell interference for UEs located near the edge of a cell having a serving Node B in OFDMA-based networks, including variants of the OFDMA transmission method such as the single-carrier FDMA (SC-FDMA) transmission method.

The signaling and measurement requirements in support of IC-FFR or IC-FTR are now considered. In the disclosed invention, the determination whether a UE belongs to the cell interior or the cell edge of a serving Node B is based on existing channel quality indication (CQI) measurements reported from each UE to its serving Node B for data scheduling purposes. The CQI is simply the short-term (over one or a few TTIs) signal-to-noise and interference ratio (SINR) experienced by a UE. It is assumed that the communication system applies scheduled transmissions where the transmission parameters such as the modulation and coding scheme (MCS) and the RBs used for the signal transmission from the serving Node B to a UE are based on the CQI measurement reports from the UEs to the serving Node B in some or all of the RBs the operating bandwidth is partitioned into, including an average CQI over all RBs (wideband CQI over the entire operating bandwidth).

The CQI measurement at the UE is based on a reference signal (also commonly referred to a pilot signal) that is transmitted by each Node B and substantially occupies the entire operating bandwidth at least during some of the TTIs. In order for the CQI measurement at each UE to capture the interference that would be experienced by the data signal transmission from the serving Node B to the UE in the RBs the operating bandwidth is partitioned into, the reference signal (RS) transmitted by the serving Node B (which for brevity will be referred to as the downlink (DL) RS) should not occupy the same sub-carriers as the RS transmitted by adjacent Node Bs. Otherwise, if the RS transmitted by all Node Bs always occupy identical sub-carriers, the CQI measurement can only capture the changing characteristics of the channel medium (short term fading characteristics) and cannot capture the interference that would be experienced by the data transmission. For an asynchronous system this is not an issue as the OFDM symbols carrying RS in one Node B do not perfectly overlap in time with the corresponding ones from the interfering Node Bs.

For a synchronous system, the embodiments further consider that the sub-carriers used for the DL RS transmission from each Node B vary per TTI according to a predetermined, pseudo-random pattern, so that there is a statistically large number of TTIs for which the RS from a reference Node B and an interfering Node B occupy different sub-carriers. Moreover, in addition to randomizing the RS position in frequency by using different sub-carriers across TTIs, the RS position can also be randomized in time by using different OFDM symbols across TTIs.

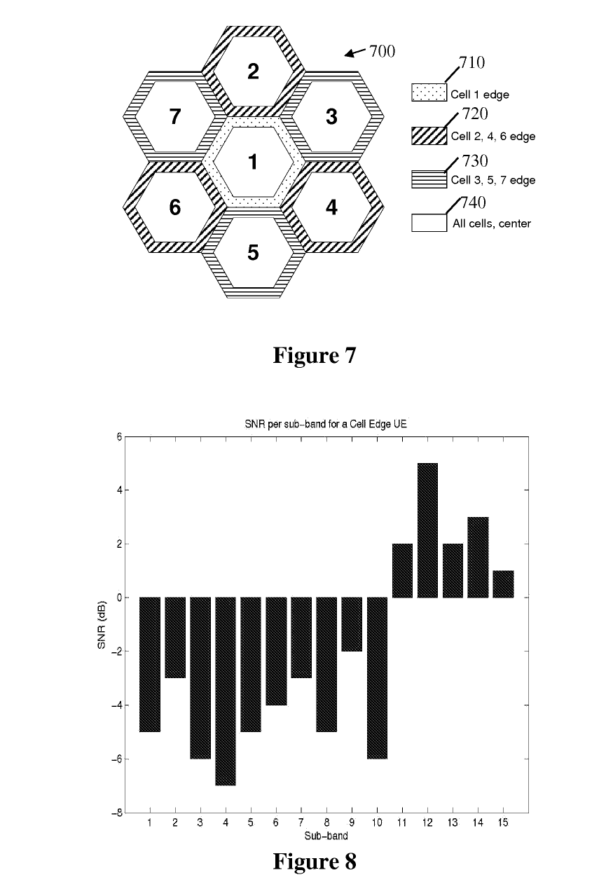

To briefly illustrate the previous concept, considering three consecutive TTIs an OFDM symbol of the TTI containing DL RS, and the exemplary setup in FIG. 7, the DL RS from Cell 1 may occupy a first, second, and third sub-carrier during the respective three TTIs, the DL RS from Cells 2, 4, and 6 may occupy a second, third, and first sub-carrier and the DL RS from Cells 3, 5, and 7 may occupy a third, first, and second sub-carrier. The said first, second, and third sub-carriers are assumed to be different (for example, the first, second, and third sub-carriers are respectively sub-carriers one, two, and three in an OFDM symbol containing DL RS). In the previous example, there is no overlap between DL RS in any of the consecutive TTIs but in case of a pseudo-random RS hopping pattern, the DL RS from a Node B in some TTIs will occupy the same sub-carriers as the DL RS from an adjacent Node B.

Alternatively, the DL RS in adjacent Node Bs can be planned to occupy different sub-carriers (or different OFDM symbols) that remain the same during all or during a substantial majority of the TTIs.

Having the DL RS occupy different sub-carriers among adjacent Node Bs, at least during some TTIs, the CQI measurement reported by the UEs to the serving Node B can be used for the classification of UEs for the purposes of IC-FFR and IC-FTR. As the UE classification remains the same over a time period that is orders of magnitude larger than the TTI duration, the CQI reports from each UE can be averaged over multiple reporting periods, where a CQI report from a UE is assumed to occur once over a small number of TTIs (for example, the CQI reporting period may be between one to ten TTIs). As substantial changes in the UE location or signal shadowing typically occur in the order of several seconds, the CQI measurement reports from each UE for the purposes of IC-FFR or IC-FTR can be averaged at the serving Node B over hundreds or thousands CQI reporting periods where the TTI duration is assumed to be in the order of a millisecond.

The averaging of the CQI reports from a UE is beneficial for several purposes. For a synchronous system, in case the DL RS from adjacent Node Bs overlap during some TTIs, averaging can statistically ensure that the TTIs for which these DL RS do not overlap are also captured and the corresponding result of CQI averaging has a component obtained during TTIs of DL RS overlap, which cannot be used for UE classification, but also a component obtained during TTIs where the RS of the serving Node B interferes with data from adjacent Node Bs. The latter can provide a measure of the interference experienced by the data transmission from the serving to the reference UE in a RB and this can be used for the UE classification for the purposes of IC-FFR or IC-FTR as it is later further explained.

CQI averaging can also be used to combat short term fading, thereby statistically eliminating variations attributed to channel variations and reliably capturing the long term fading and interference statistics experienced by the corresponding UE which can then be used for the UE classification for the purposed of IC-FFR or IC-FTR.

The following three Figures consider IC-FFR and demonstrate the use of the CQI report in RBs from a UE averaged over multiple reporting periods for UE classification. The same concept applies for the UE classification with IC-FTR where the RBs are replaced by TTIs. With IC-FTR, transmission in all RBs is assumed to always be with full power. However, similarly to IC-FFR, the classification of UEs can be based on CQI reports encompassing different TTIs. A CQI measurement obtained during TTIs where the reference Node B is allowed to schedule its cell edge UEs will indicate low interference from adjacent Node Bs while a CQI measurement obtained during TTIs where adjacent Node Bs are allowed to schedule their cell edge UEs will indicate larger corresponding interference. The relative difference of these two CQI reports can be used to classify the UEs in the reference Node B as cell edge or cell interior ones with the former indicating a larger variation in their CQI values between the aforementioned two measurement instances.

FIG. 8 shows how an exemplary CQI measurement in the different sub-bands (RBs) indicating the classification of a UE as a cell edge one and for which interference protection is required. For presentation simplicity, with IC-FFR, the last 5 out of 15 sub-bands 810 in the serving Node B are assumed reserved for cell edge UEs and the signal-to-interference and noise ratio SINR is quantized to the closest integer. In practice, the reserved RBs may not be contiguous in order to maximize the frequency diversity offered for cell edge UE scheduling. When a UE is in the cell edge, the CQI measurement in the reserved sub-bands may be affected only by the interfering signals transmitted to cell interior UEs in adjacent cells (Node Bs). The CQI measurement in the remaining sub-bands may be affected by both interfering signals to cell edge and cell interior UEs in adjacent cells. As a result, the (average) CQI values in reserved sub-bands may be larger than the ones in the remaining sub-bands of the operating bandwidth as the propagation loss of the signal power depends on the UE distance from the serving Node B and signals transmitted to cell interior UEs become more attenuated at the cell edge than signals transmitted to cell edge UEs. Based on these averaged CQI measurements, the Node B can classify the corresponding UE as a cell edge one.

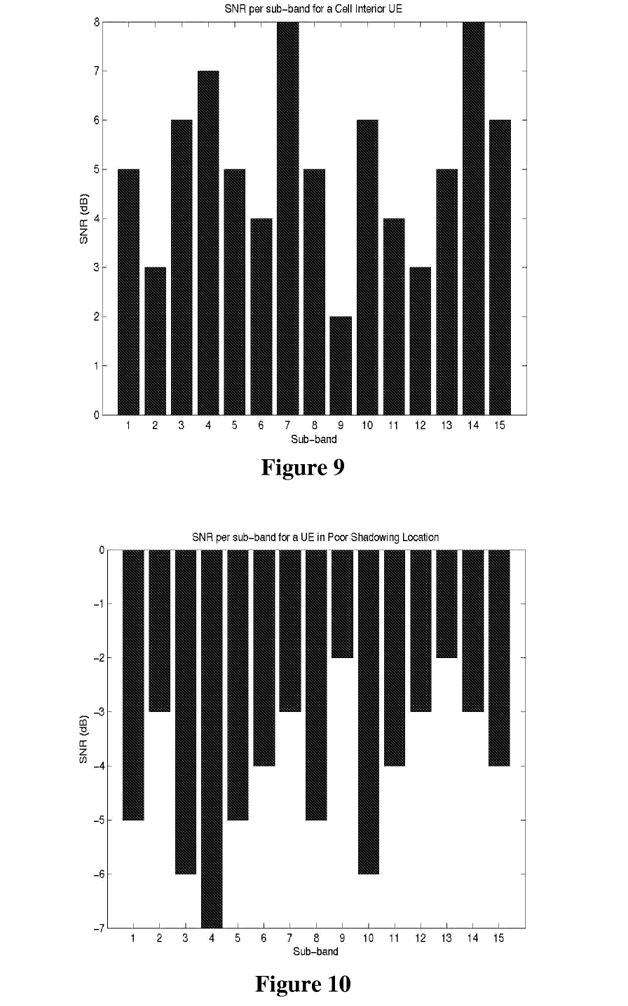

FIG. 9 shows an averaged CQI measurement from a cell interior UE. As such a UE is much more insulated to inter-cell (inter-Node B) interference (due to larger propagation losses for the interfering signals), the average CQI is similar across all sub-bands and the Node B can therefore classify the reference UE as a cell interior one. It should be noted that in this respect, the classification of a UE as a cell edge or a cell interior one is not as much a location-dependent one as it is an interference-dependent one. Although UEs experiencing larger signal propagation loss are usually ones also experiencing larger interference, this is often not the case as it is further subsequently illustrated.

FIG. 10 illustrates the case that the UE is in a poor shadowing location, experiences larger path propagation loss, and cannot benefit from interference avoidance through IC-FFR or IC-FTR. In this case, a UE classification as a cell edge one should be avoided as the reserved time or frequency resources protected by interference can be better utilized by being assigned to UEs for which such an assignment can result to reduced interference. Clearly, the CQI measurement across all sub-bands (RBs) can indicate this situation as there is CQI little variation even though a cell edge UE experiences less interference in the reserved sub-bands. Even though the CQI values are small, this is true for all sub-bands indicating that the UE is simply in a poor location for receiving the signal from the serving Node B (for example inside a building) and interference protection cannot be beneficial.

In a synchronous system where RS frequency hopping is applied, cell edge UEs may also cancel the interference cause on their RS from an RS of an adjacent Node B during TTIs where overlapping occurs. For example, if different scrambling codes are used among different Node Bs, a cell edge UE can cancel the RS from the strongest interfering Node B provided that it has acquired the corresponding scrambling codes (e.g. by reading the synchronization or broadcast channels of the interfering Node B), as required for example for handoff. If RS frequency hoping is not applied, each UE may signal an interference measurement per sub-band in addition to the CQI.

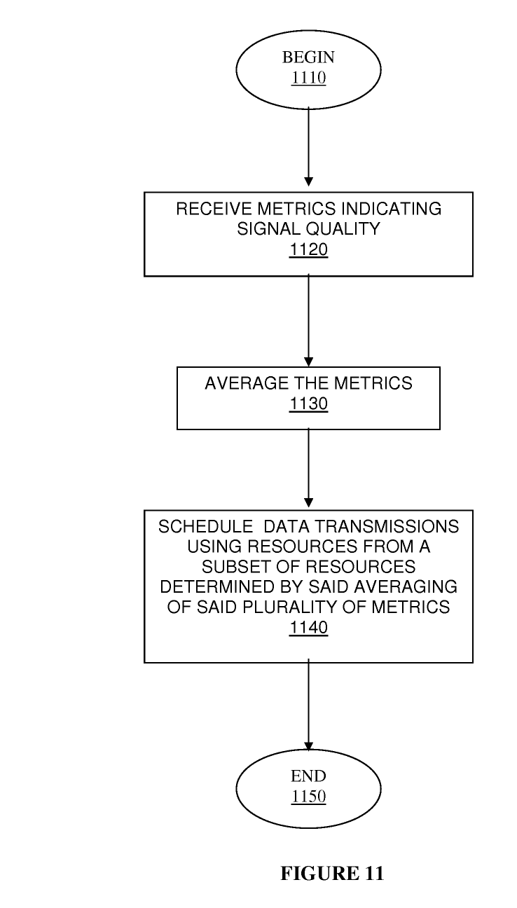

FIG. 11 is a flowchart illustrative of a method in accordance with an embodiment. A method to perform scheduling of user equipments (UEs) communicating with a reference Node B from Node Bs begins at 1110. In the preferred embodiment, Node B receives multiple metrics from user equipments UEs at 1120. The metric is an indication of signal quality.

The method continues at 1130 where the Node B, according to the preferred embodiment, averages multiple metrics received from a UE. The Node B then schedules data transmissions to or from the UE using resources from a subset of resources. This subset of resources may be determined by the averaging of the metrics provided by the UE (1140). The method ends at 1150.

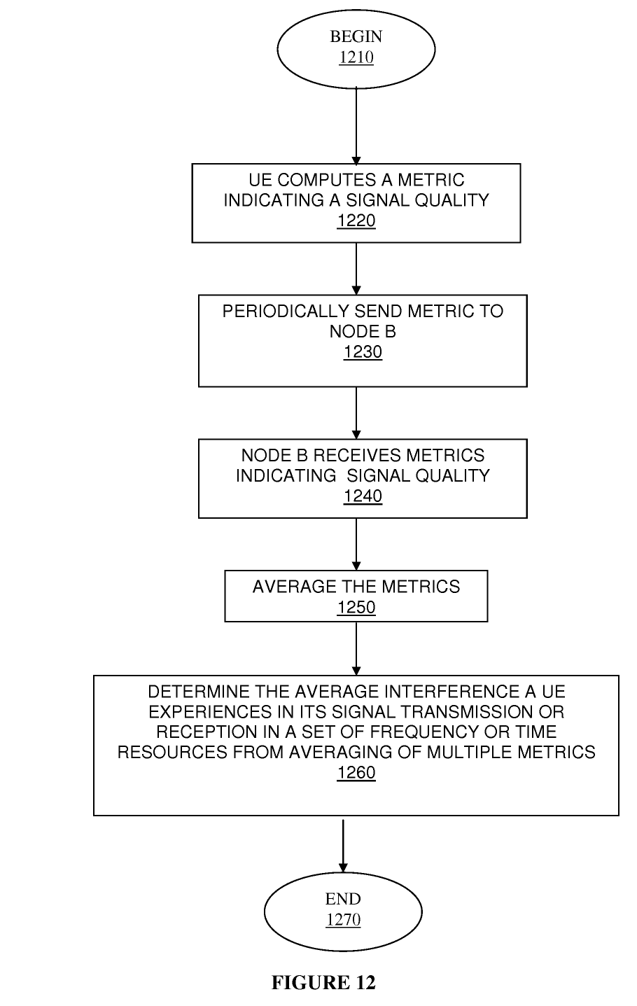

FIG. 12 is a flowchart illustrative of a method in accordance with another embodiment. A method to classify UEs communicating with a reference Node B according to the average interference said UEs experience in their signal transmission or reception begins at 1210. A UE computes a metric indicating a signal quality 1220 and sends this metric to its serving Node B 1230. The Node B receives a multiple of the metrics 1240 and averages these metrics 1250. Then Node B then determines the average interference experienced by the signal transmission or reception for the UEs in the total set of available frequency or time resources from averaging the multiple metrics 1260. The method ends 1270.

The described UE classification method avoids additional signaling overhead from UEs, such as path loss measurements or transmission power, and utilizes existing individual CQI reports the UEs send to their serving Node B for the purposes of data scheduling in a TTI (or sub-frame). Nevertheless, additional measurements, if any, may also be combined with the existing CQI ones for the UE classification.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein, but may be modified within the scope of the appended claims along with their full scope of equivalents. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. In a cellular network having a plurality of Node Bs, a method to perform scheduling of user equipments (UEs) communicating with a reference Node B from said plurality of Node Bs, said method comprising:
receiving a plurality of metrics at said reference Node B from at least one of said UEs wherein each of said plurality of metrics indicates a signal quality;
averaging said plurality of metrics at said reference Node B; and
scheduling at said reference Node B a signal transmission to or from said at least one of said UEs using resources from a subset of resources, said subset of resources determined from a set of resources by said averaging of said plurality of metrics.

2. The method of claim 1, wherein at least one of said plurality of metrics is a channel quality indication (CQI) measurement.

3. The method of claim 1, wherein said subset of resources is a subset of frequency resources determined from a set of frequency resources in accordance to interference co-ordination with fractional frequency reuse.

4. The method of claim 1, wherein said subset of resources is a subset of time resources determined from a set of time resources in accordance to interference co-ordination with fractional time reuse.

5. The method of claim 1, wherein said averaging is over at least tens of said metrics.

6. The method of claim 1, wherein at least one of said plurality of metrics is computed by said at least one of said UEs based on a reference signal transmitted by said reference Node B.

7. The method of claim 1, wherein said subset of resources is additionally determined by said reference Node B knowing the transmission restrictions applied in corresponding resources by other Node Bs in said plurality of Node Bs.

8. In a cellular network comprising a plurality of Node Bs, a method to classify UEs communicating with a reference Node B from said plurality of Node Bs according to the average interference said UEs experience in their signal transmission or reception, said method comprising:
at least one of said UEs computing a metric indicating a signal quality;
periodically sending said metric to said reference Node B;
receiving a plurality of said metrics at said reference Node B;
averaging said a plurality of said metrics at said reference Node B; and
determining at said reference Node B the average interference experienced by the signal transmission or reception for said at least one of said UEs in a set of resources from said averaging of multiple said metrics.

9. The method of claim 8, wherein at least one of said plurality of metrics is a channel quality indication (CQI) measurement.

10. The method of claim 8, wherein said averaging is over at least tens of said metrics.

11. The method of claim 8, wherein said metric is computed by said UE based on a reference signal transmitted by said reference Node B.

12. The method of claim 8, wherein said at least one of said UEs experiences different average interference in at least two subsets of said set of resources.

13. The method of claim 12, wherein said at least two subsets and said set of resources are frequency resources.

14. The method of claim 12, wherein said at least two subsets and said set of resources are time resources.
